(19) United States
(12) Patent Application Publication
(10) Pub. No.: US 2013/0033604 A1
(43) Pub. Date: Feb. 7, 2013

(54) CAMERA UNIT MOUNTING METHOD AND CAMERA UNIT

(71) Applicants: Takahito Ohshima, Kobe-shi (JP); Shunichi Uesaka, Kobe-shi (JP)

(72) Inventors: Takahito Ohshima, Kobe-shi (JP); Shunichi Uesaka, Kobe-shi (JP)

(73) Assignee: FUJITSU TEN LIMITED, Kobe-shi, Hyogo (JP)

(21) Appl. No.: 13/641,953

(22) PCT Filed: Dec. 24, 2010
(86) PCT No.: PCT/JP2010/073870

§ 371 Date: Oct. 18, 2012

(30) Foreign Application Priority Data
Apr. 20, 2010 (JP) 2010-097312

(51) Int. Cl. H04N 5/225

(52) U.S. Cl. 348/148; 348/E05.026

(57) ABSTRACT

A camera mounting method and a camera for capturing images around a vehicle to assist the driver in safe driving. An imaging lens is mounted to a side mirror so that the angle (Ψ) that the optical axis of the imaging lens makes with a direction perpendicular to the ground directly below the camera satisfies the following equation

ω/2−θ1≧Ψ≧90 °−(ω/2−θ2)

where ω represents the angle of view of the camera, θ1 the angle that a line drawn from the imaging lens to an upper end of a tire of the vehicle makes with the direction perpendicular to the ground directly below the camera, and θ2 the angle that a line drawn from the imaging lens to the top of a target whose image is to be captured by the camera makes with a line passing through the imaging lens and extending parallel to the ground.

### TECHNICAL FIELD

The present invention relates to a camera unit mounting method and a camera unit for use in an all-around view monitor system which synthesizes a bird's. eye image of a vehicle by combining images captured by a plurality of cameras mounted on the vehicle.

### BACKGROUND

Technologies related to an all-around view monitor system in which a plurality of cameras are mounted on a vehicle, and which shows a driver an image as if the vehicle were viewed from above by combining images captured by the plurality of cameras, are known in the art.

In such an all-around view monitor system, a camera unit is usually mounted on each of the rear-viewing side mirror units attached to the left and right front doors of a vehicle, but since it is difficult to secure a place for accommodating many devices inside the housing of the side mirror unit, a method is known that mounts the camera unit with its imaging lens portion protruding from the side mirror housing (for example, refer to patent document 1).

It is also known to provide a design that incorporates a camera into an upper portion of a lamp cover of a lamp house provided in each corner of a vehicle so that images can be captured by eliminating any blind spots around the vehicle, while minimizing the effect that the design will have on the exterior design of the vehicle (for example, refer to patent document 2).

Patent document 1: Japanese Unexamined Patent Publication No. 2003-327048 (FIG. 5(b))

Patent document 1: Japanese Unexamined Patent Publication No. 2000-236462 (FIG. 1)

### SUMMARY

In the all-around view monitor system, if images can be obtained that provide views of the entire (360-degree) surrounding of the vehicle and views taken perpendicular (height) relative to the ground, useful images that contribute to safe driving can be seen by the driver. Accordingly, when mounting the camera unit to the side mirror, it is preferable to mount it, not inside the side mirror housing, but in such a manner as to protrude from the side mirror housing so that an image of the vehicle's surrounding can be captured over a wide range.

However, it is not sufficient to simply mount the camera unit in such a manner as to protrude from the side mirror housing. When the camera unit is installed with its imaging lens facing straight down, an image of the vehicle's surrounding in the height direction cannot be adequately obtained. This can lead to a situation where, for example, the driver fails to notice the presence of an occupant in a nearby vehicle, in which case, if the occupant suddenly gets out of that vehicle, a minor collision may result. Further, if the driver does not know in which direction the face of a person located near the vehicle is turned, there arises the problem that the driver may start his vehicle without knowing that the person is not aware of the presence of the vehicle, and an accident may result.

On the other hand, when the camera unit is installed with its imaging lens pointed in a horizontal direction relative to the ground, an image providing a view in the height direction can be adequately obtained but, since a view near the tire of the vehicle cannot be obtained, the driver cannot fully check the surroundings of the vehicle, and therefore, such an image is inadequate for the purpose of assisting safe driving. Furthermore, when the imaging lens is mounted so as to point in a horizontal direction relative to the ground, there arises the problem that many of the images captured are blank images and most of the acquired information has no direct relationship to the driving, such information thus being rendered useless and inadequate for the purpose of assisting safe driving.

Accordingly, it is an object of the present invention to provide a camera unit mounting method and a camera unit for capturing images around a vehicle that are best suited to assist the driver in safe driving.

In a camera unit mounting method according to the present invention, an imaging lens is mounted to a side mirror housing so that the angle (Ψ) that the optical axis of the imaging lens makes with a direction perpendicular to the ground directly below the camera unit satisfies the following equation (1)

ω/2−θ1≧Ψ≧90°−(ω/2−θ2) (1)

where ω represents the angle of view of the camera unit, θ1 the angle that a line drawn from the imaging lens to an upper end of a tire of the vehicle makes with the direction perpendicular to the ground directly below the camera unit, and θ2 the angle that a line drawn from the imaging lens to the top of a target whose image is to be captured by the camera unit makes with a line passing through the imaging lens and extending in a direction parallel to the ground.

A camera unit according to the present invention comprises an imaging lens which, is mounted to a side mirror housing so that the angle (Ψ) that the optical axis of the imaging lens makes with a direction perpendicular to the ground directly below the camera unit satisfies the following equation (1)

ω/2−θ1≧Ψ≧90°−(ω/2−θ2) (1)

where ω represents the angle of view of the camera unit, θ1 the angle that a line drawn from the imaging lens to an upper end of a tire of the vehicle makes with the direction perpendicular to the ground directly below the camera unit, and θ2 the angle that a line drawn from the imaging lens to the top of a target whose image is to be captured by the camera unit makes with a line passing through the imaging lens and extending in a direction parallel to the ground.

According to the camera unit mounting method and the camera unit provided by the present invention, information concerning not only the area near the vehicle's tire but also the vehicle's surroundings in the height direction and contributing directly to the driver's safe driving can be sufficiently provided to the driver, and safe driving can thus be promoted.

### BRIEF DESCRIPTION OF THE DRAWINGS

FIG. 1(a) is a diagram showing a camera assembly 10 mounted on a side mirror housing 2, as viewed directly from the rear of a vehicle, and

FIG. 1(b) is a diagram showing the camera assembly 10 mounted on the side mirror housing 2, as viewed directly from the side of the vehicle.

FIG. 2 is an exploded perspective view of the camera assembly 10.

FIG. 3(a) is a diagram showing the camera assembly 10 as viewed directly from the top thereof,

FIG. 3(b) is a diagram showing the camera assembly 10 as viewed directly from the side thereof,

FIG. 3(c) is a diagram showing the rear side of the camera assembly 10, and

FIG. 3(d) is a diagram showing the camera assembly 10 from which a bracket 40 has been removed.

FIG. 4 is a diagram showing one example of a wiring arrangement in the vehicle 1.

FIG. 5 is a diagram schematically showing the configuration of an all-around view monitor system.

FIG. 6 is a diagram for explaining a method of determining the angle Iv of the optical axis A of a camera unit 30 included in the camera assembly 10 mounted on the side mirror housing 2.

FIG. 7(a) is a diagram showing an alternative camera assembly 130 as viewed directly from the top thereof,

FIG. 7(b) is a diagram showing the alternative camera assembly 130 as viewed directly from the side thereof, and

FIG. 7(c) is a diagram showing the camera assembly 10 as viewed directly from the side thereof.

FIG. 8 is a diagram for explaining another alternative camera assembly 140.

### DESCRIPTION OF EMBODIMENTS

A camera unit mounting method and a camera unit according to the present invention will be described below with reference to the drawings. It will, however, be noted that the technical scope of the present invention is not limited to the specific embodiments described herein but extends to the inventions described in the appended claims and their equivalents.

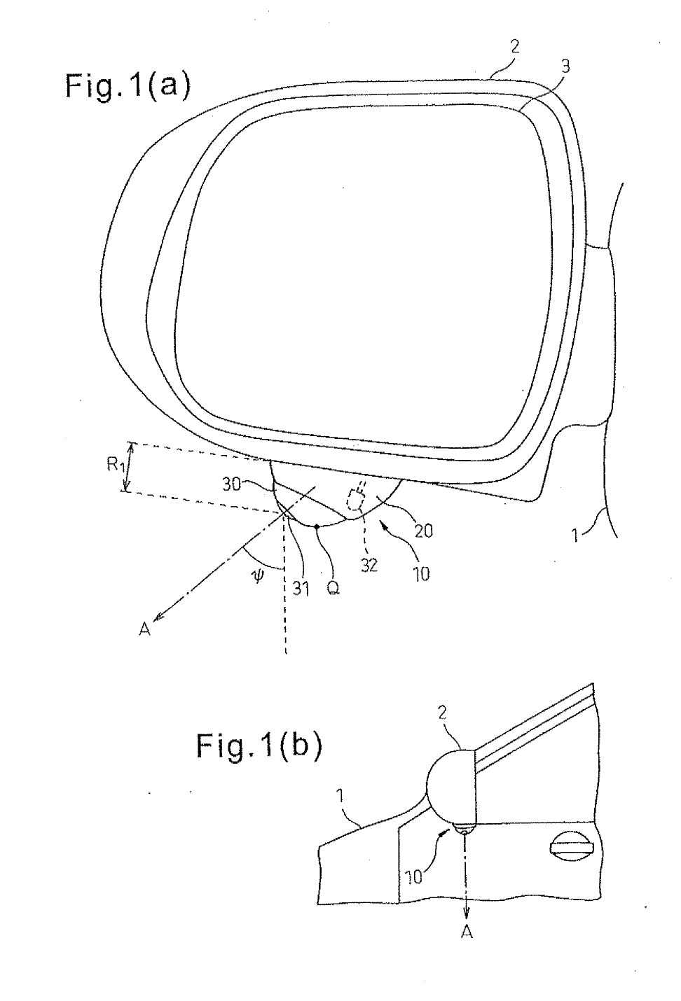

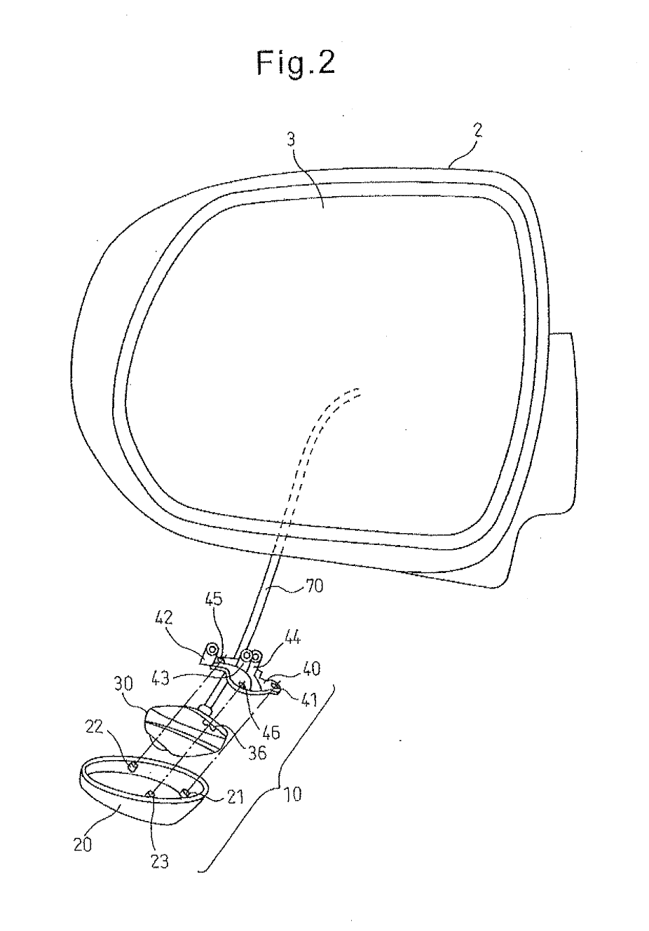

FIG. 1 is a diagram showing a camera assembly 10 mounted on a side mirror housing 2, and FIG. 2 is an exploded perspective view of the camera assembly 10.

The camera assembly 10 includes a camera cover 20, a camera unit 30, and a bracket 40. The camera cover 20 and the bracket 40 each serve as a camera unit mounting assisting member An opening is provided in the lower part of the side mirror housing 2, and the camera unit 30 is mounted in the lower part of the side mirror housing 2 by fastening screws into threaded holes 42, 43, and 44 provided on the bracket 40.

That is, since the camera unit 30 and the camera. cover 20 are both held fixed to the bracket 40, the camera assembly 10 is fixed to the lower part of the side mirror housing 2 by fastening the bracket 40 with screws relative to the side mirror housing 2.

Further, a signal cable 70, which is used to convey image information captured by the camera unit 30 and to transmit control signals for controlling camera operation to the camera unit 30, is passed through the opening and connected to an ECU 80 mounted in a vehicle 1.

The camera unit 30 includes an imaging lens 31, and when viewed directly from the rear of the vehicle 1 (see FIG. 1(a)), the optical axis A of the imaging lens 31 is oriented at an angle Ψ (in the example of FIG. 1,) 45°) relative to the direction pointing directly below the camera unit (the direction perpendicular to the ground). When viewed directly from the side of the vehicle 1 (see FIG. 1(b)), the optical axis A of the imaging lens 31 is not tilted in the horizontal direction of the vehicle. The tilting of the optical axis in the horizontal direction of the vehicle may depend on the shape of the side mirror housing 2; therefore, the only requirement is that the optical axis be not substantially tilted in the horizontal direction.

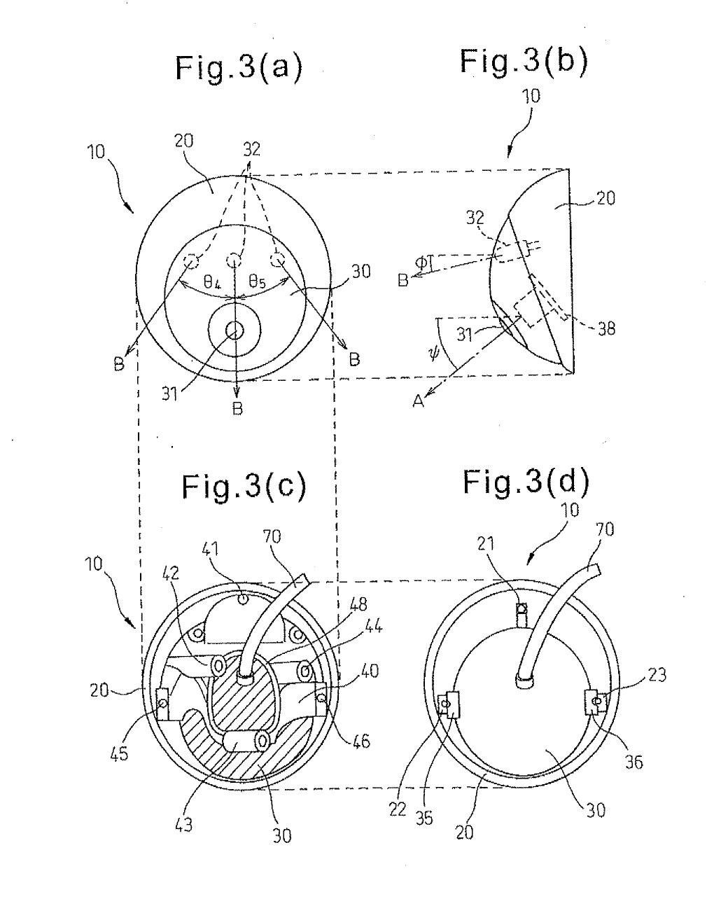

FIG. 3 is a diagram for explaining the camera assembly 10.

FIG. 3(a) is a diagram showing the front side of the camera assembly 10, and FIG. 3(b) is a side view of the camera assembly 10.

The camera unit 30 includes an imaging unit 38 for capturing an image through the imaging lens 31. The optical axis A of the imaging lens 31 is oriented at an angle Ψ (in the example of FIG. 1, 45°) relative to the direction pointing directly below the camera unit (the direction perpendicular to the ground). The imaging unit 38 is constructed from a CMOS sensor or the like. The camera unit 30 uses, for example, a wide--angle lens as the imaging lens 31 to provide a wide angle of view (ω) of 190°. However, this angle of view is only an example and is not limited to any particular angle, the only requirement being an ability to provide a wide-angle view.

The camera unit 30 also includes three LEDs 32 for radiating near-infrared light. The three LEDs 32 are arranged so as to point in direction B and spaced apart from one another by θ4 (in the example of FIG. 3, 65°) and θ5 (in the example of FIG. 3, 65°), respectively, with their optical axes oriented at an angle φ (in the example of FIG. 1, 23°) relative to the direction pointing directly below the camera unit (the direction perpendicular to the ground) (see FIG. 3(b)).

Since the infrared light emitted from the LEDs 32 illuminates the area, including the ground, tire, and a portion of the vehicle 1, below the side mirror housing 2, the imaging unit 38 can clearly capture an image of the area below the side mirror housing 2 even in the nighttime. In the camera unit 30, the front part of each of the three LED light sources 32 (as viewed in the direction of light emission) is covered by a resin transparent to the wavelength of the light emitted from the LED 32.

In the camera unit 30, the LEDs 32 are arranged in close proximity to one another so that images can be captured clearly even in at nighttime. The optical axis A of the imaging lens 31 and the optical axis of each LED 32 are oriented in the same direction but at different angles, but if the optical axis A of the imaging lens 31 is oriented parallel to the direction B in which the LED 32 is pointed, or if they are oriented in directions opposite to each other, there arises the problem that the LED light source is reflected into the imaging lens, resulting in an inability to capture a clear image. To address this, in the camera unit 30, the optical axis A of the imaging lens 31 is oriented at an angle Ψ (in the example of FIG. 1, 45°) relative to the direction pointing directly below the camera unit (the direction perpendicular to the ground), while the direction B in which the three LEDs 32 are pointed is set at an angle φ (in the example of FIG. 1, 23°) relative to the direction pointing directly below the camera unit (the direction perpendicular to the ground), thus displacing the directions A and 8 relative to each other (see FIG. 3(b)). The problem of the light source reflection is also solved by disposing the LEDs 32 inwardly of the front face of the camera unit 30.

FIG. 3(c) is a diagram showing the rear side of the camera assembly 10, and FIG. 3(d) is a diagram showing the condition in which the bracket 40 is removed from FIG. 3(c).

Threaded holes 21, 22, and 23 are provided on the back surface of the camera cover 20. Planar protrusions 35 and 36 for registration are provided on the side of the camera unit 30 opposite from the imaging lens 31. The bracket 40 is provided with the screw holes 41, 45, and 46 for connecting to the camera cover 20, the threaded holes 42, 43, and 44 for fastening with screws from inside the side mirror housing 2, and the opening 48 through which the signal cable 70 connected to the camera unit 30 is passed through.

The bracket 40 and the camera cover 20 are connected together by fastening screws into the screw holes 41, 45, and 46 and threaded holes 42, 43, and 44 provided on the bracket 40. At this time, the planar protrusions 35 and 36 of the camera unit 30 are positioned in such a manner as to be sandwiched between the threaded holes 22 and 23 of the camera cover 20 and the screw holes 45 and 46 of the bracket 40, respectively. The camera unit 30 is thus secured in a position between the camera cover 20 and the bracket 40.

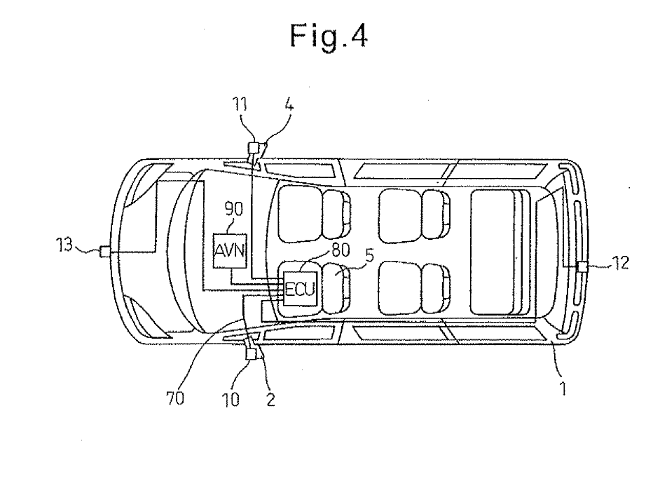

FIG. 4 is a diagram showing one example of a wiring arrangement in the vehicle 1.

The camera assembly 10 described with reference to FIGS. 1 to 3 is mounted on the left side mirror housing 2 of the vehicle 1, and a similar camera assembly 11 is mounted on the Tight side mirror housing 4 of the vehicle 1, as shown in FIG. 4. Further, a rear camera 12 for capturing a view rearward of the vehicle 1 is mounted on the rear of the vehicle 1, while a front camera 13 for capturing a frontward view of the vehicle 1 is mounted on the front of the vehicle 1.

The signal cable 70 connected to the camera unit 30 included in the camera assembly 10, the signal cable from the camera assembly 11 mounted on the right side mirror housing 4 of the vehicle 1, the signal cable from the rear camera 12, and the signal cable from the front camera 13 are connected to the ECU 80.

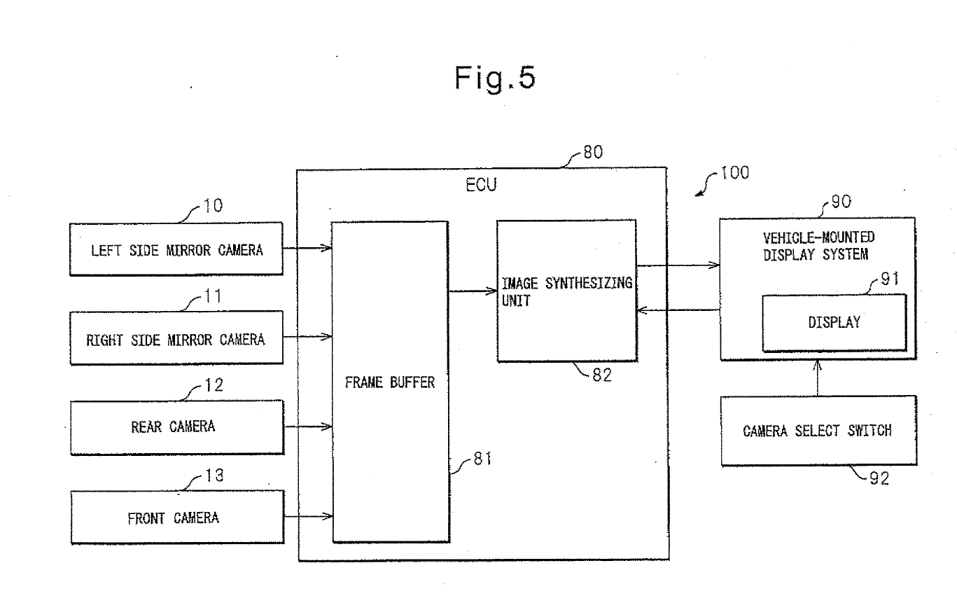

FIG. 5 is a diagram schematically showing the configuration of an all-around view monitor system 100.

The all-around view monitor system 100 comprises: the camera assembly 10 mounted on the left side mirror housing 2; the camera assembly 11 mounted on the right side mirror housing 4; the rear camera 12; the front camera 13; the ECU (electronic control unit) 80 which generates all-around view image data by combining the images captured by the respective cameras; a vehicle-mounted display system (navigation system) 90 which receives the generated all-around view image data and displays the data on a display 91; and a camera select switch 92.

For example, as shown in FIG. 4, the ECU 80 is placed under the passenger's seat 5 in the vehicle 1, and is connected via cable, etc., to the camera assembly (left side camera) 10, the camera assembly (right side camera) 11, the rear camera 12, the front camera 13, and the vehicle-mounted display system 90 which includes the display 91 mounted on the front panel.

By operating the camera select switch 92, either a virtual all-around view image showing a bird's eye, three-dimensional view of the surroundings of the vehicle 1 or an image captured by a desired one of the cameras can be selected for display on the display 91. It is also possible to switch the mode (for example, navigation mode) displayed by the vehicle-mounted display system 90 to a camera image mode. The camera select switch 92 may be provided as a dedicated switch on the front panel of the vehicle 1, or some other switch Of button included in the vehicle-mounted display system 90 may be configured to also serve as the camera select switch 92.

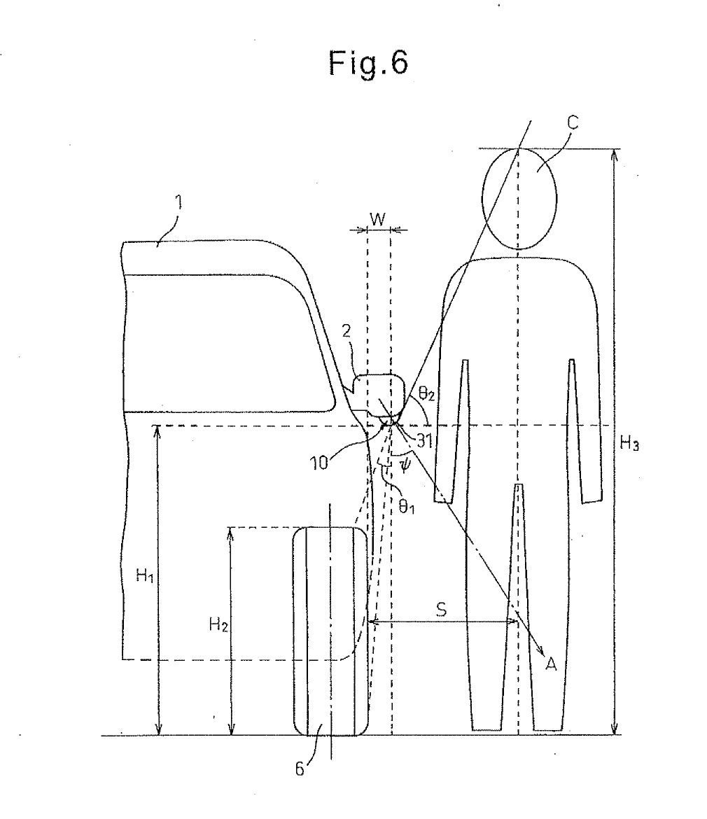

FIG. 6 is a diagram for explaining a method of determining the angle Ψ (°) of the optical axis A of the camera unit 30 included in the camera assembly 10 mounted on the side mirror housing 2.

When synthesizing an all-around view image by combining the images captured by the respective cameras, the following requirements may have to be considered for the field of view of the image to be captured by the camera unit 30 mounted on the side mirror housing 2.

Requirement 1: Since the system is designed to assist parking by checking the movement of the vehicle and the area near the vehicle's tire, the camera must be able to capture an image of the road surface and the vehicle's tire contacting the road surface.

Requirement 2: When capturing an image of the vehicle's surrounding in the height direction (the direction perpendicular to the ground), the camera must be able to capture an entire image of a person or vehicle located nearby. When an entire image of a person or vehicle located in the surrounding area is shown, the driver can check in which direction the face of the person located nearby, or the face of an occupant in the nearby vehicle, is turned, and the driver can thus operate the vehicle carefully. If the direction in which the person's face is turned cannot be checked, a minor collision may result since it is not possible to predict the next move of that person; therefore, merely capturing an image, for example, only of the legs of the person is not sufficient for assisting safe driving.

As shown in FIG. 6, let H1 (mm) represent the height from the ground to the imaging lens 31 of the camera unit 30, H2 (mm) represent the height of the tire 6 of the vehicle 1, H3 (mm) represent the height from the ground to the top of the head of the person C standing near the vehicle, S (mm) represent the distance from the vehicle 1 to the person C, and W (mm) represent the distance from the vehicle 1 to the imaging lens 31 of the camera unit 30. Further, let ω (°) represent the angle of view of the imaging lens 31 of the camera unit 30, θ1 (°) represent the angle that a line drawn from the imaging lens 31 of the camera unit 30 to an upper end of the tire 6 makes with the direction pointing directly below the S imaging lens 31, and θ2 (°) represent the angle that a line drawn from the imaging lens 31 of the camera unit 30 to the top of the head of the person C makes with a line passing horizontally through the imaging lens 31. It is assumed that the optical axis A coincides with the center of the angle of view ω of the camera unit 30.

From the above requirement 1, θ1=arctan(W/(H1−H2).

In this case, since the camera unit 30 has the angle of view ω, if the angle Ψ of the optical axis A of the camera unit 30 is set so as to satisfy the following equation (2), the imaging unit 38 can capture an image containing the upper end of the tire 6.

Ψ≦ω/2−θ1 (2)

From the above requirement 2, θ2=arctan((H3−H1)/(S−W)).

In this case, since the camera unit 30 has the angle of view ω, if the angle ω of the optical axis A of the camera unit 30 is set so as to satisfy the following equation (3), the imaging unit 38 can capture an image containing the top of the head of the person C standing right at the side of the camera unit 30.

Ψ≧90°−(ω/2−θ2) (3)

Therefore, the angle Ψ should be set to satisfy both the equations (2) and (3).

That is, when the imaging lens 31 of the camera unit 30 is positioned by determining the angle Ψ of the optical axis A so as to satisfy the following equation (1), an image that satisfies both the requirements 1 and 2 can be captured.

ω/2−θ1≧Ψ≧90°−(ω/2−θ2) (1)

When H1=1200 mm, H2=700 mm, H3=2000 mm, W=150 mm, S=2000 mm, and ω=190°, for example, since θ1 is about 17°, and θ2 is about 25°, it follows that the angle Ψ should be set so as to fall within a range of not smaller than 20° and not greater than 78°. These values have been set by assuming that the height of the person C is 2 m (H3=2000 mm) at the maximum, and that the person C located within 2 m (S=2000 mm) of the vehicle 1 needs attention. The distance S is set from 1000 to 2000 mm, assuming that this range is the range that the driver should pay attention to during driving. When the imaging lens 31 of the camera unit 30 is installed with the angle Ψ of the optical axis A set so as to fall within the above defined range, an image that satisfies both the requirements 1 and 2 can be obtained.

While the above example has been described by assuming that the target whose image is to be captured in the vicinity of the vehicle is a person, the target is not limited to a person but may be a building or a vehicle, and it is preferable to capture an entire image of the target located in the vicinity of the vehicle.

If the imaging lens 31 of the camera unit 30 is positioned so as to point directly below, rain drops, etc., may flow along the side mirror housing 2 and the camera cover 20 and adhere to the lowermost portion of the camera unit 30, causing the problem that a clear image cannot be captured. Accordingly, it is preferable that the imaging lens 31 of the camera unit 30 is positioned so as not to be located in the lowermost portion of the camera unit 30. For the same reason, it is preferable that the LEDs 32 of the camera unit 30 are also positioned so as not to be located in the lowermost portion of the camera unit 30.

As described above, since the angle Ψ of the optical axis A is set so as to fall within the above defined range, the imaging lens 31 of the camera unit 30 is positioned with its optical axis A oriented outwardly of the lowermost point of the camera unit 30 relative to the vehicle 1, while the LEDs 32 of the camera unit 30 are each positioned so as to point outwardly at a smaller angle than the optical axis A of the imaging lens 31 (see FIG. 1). In the example shown in FIGS. 1 to 3, the optical axis A of the imaging lens 31 is oriented so as to point outwardly at an angle of 45° relative to the direction perpendicular to the ground, while the optical axis B of each LED 32 is oriented so as to point outwardly at an angle of 23° relative to the direction perpendicular to the ground (see FIG. 3(b)). In FIG. 1, the lowermost point of the camera unit 30 is indicated at Q.

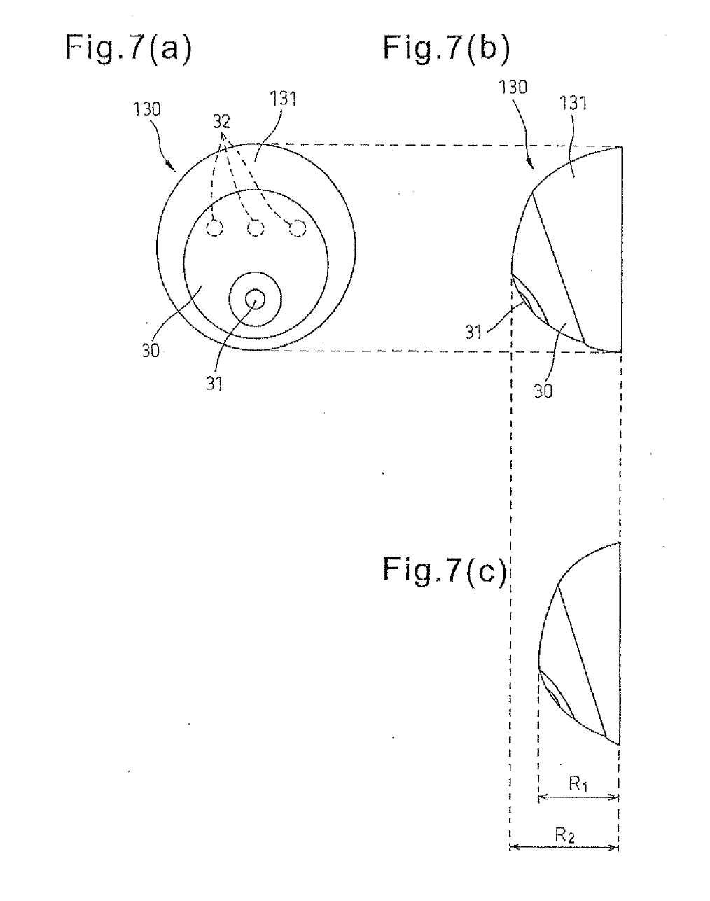

FIG. 7 is a diagram for explaining an alternative camera assembly 130. FIG. 7(a) is a top view of the alternative camera assembly 130, FIG. 7(b) is a side view of the camera assembly 130, and FIG. 7(c) is a side view of the same camera assembly 10 as that shown in FIG. 3(b).

Since the all-around view image is an image showing a bird's eye, three-dimensional view of the vehicle's surroundings that is synthesized by combining the images captured by the plurality of cameras, the camera assemblies 10 and 11 are mounted on the side mirror housings 2 and 4 so as to obtain images on the left and right sides of the vehicle. In order to obtain not only an image of the road surface but also an image of the side area including the area where the vehicle's tire contacts the road surface for the creation of the all-around view image, the optical axis A of the imaging lens 31 of the camera unit 30 is oriented so as not to point directly below but at an angle Ψ that satisfies the earlier given equation (1). In the example of FIGS. 1 to 3, the angle Ψ is 45°.

Since the camera unit 30 needs to be installed with the optical axis A of the imaging lens 31 oriented at the angle Ψ, as described above, if an image necessary to create an all-around view image is to be captured, the imaging lens 31 of the camera unit 30 must protrude downward from the side mirror housing 2 by a prescribed distance. In the case of the camera assembly 10 of FIGS. 1 to 3, with the bracket 40 and the camera cover 20 connected together, the imaging lens 31 of the camera unit 30 is made to protrude downward from the side mirror housing 2 by a distance R1 (for example, R1=25 mm) (see FIG. 1). If the camera unit 30 did not protrude downward from the side mirror housing 2, the side mirror housing 2 would be located within the image capturing range, so that a portion'of the side mirror housing would appear in the captured image, rendering the image not suitable for generating a synthesized image.

However, the shape of the side mirror housing varies depending on vehicle model, and the position of the lower face of the side mirror housing (i.e., the height from the ground) also varies depending on vehicle model; as a result, if a desired image capturing area is to be obtained, the camera unit must be designed for each, vehicle model so that the optical axis A of the imaging lens 31 of the camera unit 30 is oriented at an optimum angle. If the camera unit has to be designed to suit each specific vehicle model, the manufacturing cost will increase, leading to the problem that the product cannot be provided at low cost to the consumer, and besides, maintenance and repair service cannot be readily provided in the event of failure of the camera unit.

To address this, in the camera assembly 130 shown in FIGS. 7(a) and 7(b), provisions are made so that the amount of protrusion of the imaging lens 31 of the camera unit 30 can be changed to R2 (for example, R2=40 mm) according to the vehicle model by just changing the camera cover 131, eliminating the need to change the design of the camera unit 30. In FIG. 7(c), a side view of the camera assembly 10 of FIG. 3(b) is shown for the case of the amount of protrusion R1. In this way, by making a plurality of kinds of camera covers available in advance, the camera unit can be properly mounted onto the side mirror housing of any vehicle model without having to change the camera unit according to the vehicle model.

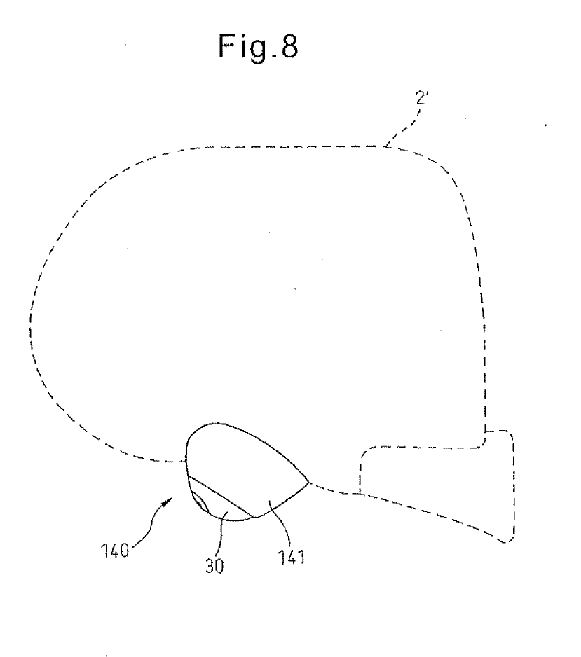

FIG. 8 is a diagram for explaining another alternative camera assembly 140.

In the case of FIG. 8, the lower face of the side mirror housing 2′ has a three-dimensionally curved shape. In this case, the camera unit 30 can be mounted by using a camera cover 141 whose portion mating with the side mirror housing 2 is curved to conform with the three-dimensionally curved shape of the lower face of the side mirror housing 2′. In this way, by using a camera cover that matches the shape of the lower face of the side mirror housing, it is possible to properly mount the camera unit onto a side mirror housing having any shape.

As described above, by providing a camera cover that matches each specific vehicle model, not only can the all-around view monitor system be provided at low cost to the consumer, but maintenance and repair can also be readily provided in the event of failure of the camera unit.

What is claimed is:

1. A camera unit mounting method for mounting a camera unit having an imaging lens to a side mirror housing of a vehicle, wherein said imaging lens is mounted to said side mirror housing so that an angle (Ψ) that an optical axis of said imaging lens makes with a direction perpendicular to the ground directly below said camera unit satisfies the following equation (1)
ω/2−θ1≧Ψ≧90°−(ω/2−θ2) (1)
where ω represents an angle of view of said camera unit, θ1 an angle that a line drawn from said imaging lens to an upper end of a tire of said vehicle makes with the direction perpendicular to the ground directly below said camera unit, and θ2 an angle that a line drawn from said imaging lens to the top of a target whose image is to be captured by said camera unit makes with a line passing through said imaging lens and extending in a direction parallel to said ground.

2. The camera unit mounting method according to claim 1, wherein the angle (Ψ) that the optical axis of said imaging lens makes with the direction perpendicular to the ground directly below said camera unit is set so as to fall within a range of not smaller than 20° and not greater than 75°.

3. The camera unit mounting method according to claim 1, wherein said imaging lens is positioned outwardly of a lowermost point of said camera unit relative to said vehicle.

4. The camera unit mounting method according to claim 1, wherein said camera unit includes an LED light source, and said LED light source is disposed inwardly of a front face of said camera unit so as to be located inside said camera unit.

5. The camera unit mounting method according to claim 1, wherein said camera unit is mounted with the optical axis of said imaging lens fixed by means of a cover member.

6. A camera unit mounted on a side mirror housing of a vehicle, comprising:
an imaging lens which is mounted to said side mirror housing so that an angle (Ψ) that an optical axis of said imaging lens makes with a direction perpendicular to the ground directly below said camera unit satisfies the following equation (1)
ω/2−θ1≧Ψ≧90°−(ω/2−θ2) (1)
where ω represents an angle of view of said camera unit, θ1 an angle that a line drawn from said imaging lens to an upper end of a tire of said vehicle makes with the direction perpendicular to the ground directly below said camera unit, and θ2 an angle that a line drawn from said imaging lens to the top of a target whose image is to be captured by said camera unit makes with a line passing through said imaging lens and extending in a direction parallel to said ground.
